(19) United States
(12) Patent Application Publication
(10) Pub. No.: US 2024/0076488 A1
(43) Pub. Date: Mar. 7, 2024

(54) ELECTRICALLY CONDUCTIVE COMPOSITIONS CAPABLE OF SINTERING

(71) Applicant: Henkel AG & Co. KGaA, Duesseldorf (DE)

(72) Inventors: Bo Xia, Irvine, CA (US); Qizhuo Zhuo, Irvine, CA (US); Xinpei Cao, Irvine, CA (US); Xuan Hong, Irvine, CA (US)

(21) Appl. No.: 18/497,762

(22) Filed: Oct. 30, 2023

Related U.S. Application Data
(63) Continuation of application No. PCT/US2022/026993, filed on Apr. 29, 2022.
(60) Provisional application No. 63/182,179, filed on Apr. 30, 2021.

(51) Int. Cl. C08L 63/00; C08K 3/08; C08K 3/36; C08K 9/06; H01B 1/22

(52) U.S. Cl. CPC C08L 63/00; C08K 3/08; C08K 3/36; C08K 9/06; H01B 1/22; C08K 2003/0806; C08K 2201/001; C08K 2201/005

(57) ABSTRACT

Provided herein is an electrically conductive composition capable of sintering. More particularly, the electrically conductive composition comprises sinterable silver particles dispersed in a binder resin, which binder resin is not yet in a fully cured state when the composition is heated to a temperature at which the silver particles start to sinter.

### BACKGROUND

### Field

Provided herein is an electrically conductive composition capable of sintering. More particularly, the electrically conductive composition comprises sinterable silver particles dispersed in a binder resin, which binder resin is not yet in a fully cured state when the composition is heated to a temperature at which the silver particles start to sinter.

### Brief Description of Related Technology

Sinterable compositions are known. See e.g. U.S. Pat. Nos. 8,974,705; 10,000,670; 10,141,283; and 10,446,518; and US Patent Application Publication Nos. 2016/0151864; 2017/0018325; and 2018/0056449.

Sinterable compositions are desirable for conductive adhesives and pastes because they tend to offer improved conductivity over similar adhesives and pastes filled with conductive particles. However, sinterable compositions oftentimes suffer from drawbacks in the development of certain physical properties, which are believed to be inferior in some applications. In the effort to achieve higher conductivity, greater filler loadings are usefully implemented. However, those greater filler loadings lead to brittleness and higher stress, which are just two of such physical properties that suffer. Nonetheless some end users have accepted that trade off as their commercial application can tolerate such compromised physical properties in order to achieve higher conductivity. But others, particularly where large die are involved, are not so agreeable as delamination may occur during temperature cycling.

Accordingly, it would be desirable to provide a sinterable composition that not only exhibits improved conductivity but also demonstrates flexibility and strength that one might find in a conductive adhesive and paste.

### SUMMARY

The present invention provides such a sought after electrically conductive composition capable of sintering.

More specifically, provided herein is a composition for a sintering paste, comprising:
in an amount of about 2 to about 15 percent by weight, a binder resin comprising a thermosetting resin (such as desirably one or more epoxy monomers, oligomers, or polymers); a silane adhesion promoter; and a curing agent;
in an amount of about 65 to about 93 percent by weight, a silver particle component having a particle size in the range of about 1 to about 7 μm, and optionally a second silver particle having a particle size in the range of about 0.3 to about 2 μm;
in an amount of about 1 to about 10 percent by weight, one or more fillers having a particle size in a range of about 1 to about 20 μm, such as about 1 to about 10 μm, and selected from polymeric materials, inorganic materials and combinations thereof; and
optionally an organic diluent.

The composition, when cured or sintered, has a shear strength on 7×7 mm die of at least 25 kg/mm² at 260° C.; and the composition demonstrates a thermal conductivity of 70 W/m·K.

Significantly, the composition is characterized in that, when heated to a temperature at which the silver powder and silver flake starts to sinter, the binder resin is not yet in a fully cured or fully dried state. That is, the curing or drying properties of the binder resin ensure that it is not in a set state at the onset of silver sintering. For example, curing of the binder resin may not have commenced at the onset of silver sintering or the binder resin may be in a partially cured or a partially dried state at the onset of silver particle sintering.

In accordance with a second aspect of the present invention, there is provided a method of using the inventive compositions, the method comprising the steps of:
i) providing a substrate;
ii) providing a die;
iii) depositing onto at least one of the substrate or the die an inventive composition; and
iv) heating the composition at a temperature of about 250° C. for sufficient time to both sinter the silver powder contained in the composition and to fully cure the composition.

### DETAILED DESCRIPTION

As noted above, provided herein is a composition for a sintering paste, comprising:
in an amount of about 2 to about 15 percent by weight, a binder resin comprising a thermosetting resin (such as desirably one or more epoxy monomers, oligomers, or polymers); a silane adhesion promoter; and a curing agent;
in an amount of about 65 to about 93 percent by weight, a silver particle component having a particle size in the range of about 1 to about 7 μm, and optionally a second silver particle having a particle size in the range of about 0.3 to about 2 μm;
in an amount of about 1 to about 10 percent by weight, one or more fillers having a particle size in a range of about 1 to about 20 μm, such as about 1 to about 5 μm, and selected from polymeric materials, inorganic materials and combinations thereof; and
optionally an organic diluent.

The composition, when cured or sintered, has a shear strength on 7×7 mm die of at least 25 kg/mm² at 260° C.; and the composition demonstrates a thermal conductivity of 70 W/m·K.

Significantly, the composition is characterized in that, when heated to a temperature at which the silver particles start to sinter, the binder resin is not yet in a fully cured state. That is, the curing properties of the binder resin ensure that it is not in a set state at the onset of silver sintering. For example, curing of the binder resin may not have commenced at the onset of silver particle sintering or the binder resin may be in a partially cured or a partially dried state at the onset of silver particle sintering.

The binder resin ordinarily includes a thermosetting resin, such as one selected from epoxy resins; oxetane resins; oxazoline resins; benzoxazine; resole; maleimides; cyanate esters; acrylate resins; methacrylate resins; maleates; fumarates; itaconates; vinyl esters; vinyl ethers; cyanoacrylates; styrenics; and combinations thereof. Preferably, the thermosetting resin comprises one or more of an epoxy resin and a (meth)acrylate resin. In particular, the thermosetting resin comprises an epoxy resin.

Desirably, the binder resin should include a hydrogenated aromatic epoxy resin, a cycloaliphatic epoxy resin or a mixture thereof. In particular, the binder resin should include an epoxy resin selected from 1,2-cyclohexanedicarboxylic acid diglycidyl ester; bis(4-hydroxycylohexyl)methanediglycidyl ether; 4-methylhexahydrophthalic acid diglycidyl ester; 2,2-bis(4-hydroxycyclohexyl)propane diglycidyl ether; 3,4-epoxycyclohexylmethyl-3′,4′-epoxycylohexane carboxylate; bis(3,4-epoxycyclohexylmethyl)adipate and mixtures thereof.

The binder resin in one embodiment may include a hydrogenated aromatic epoxy resin, a cycloaliphatic epoxy resin or a mixture thereof, and in order to enhance certain properties and features further including an epoxy resin selected from urethane-modified epoxy resins; isocyanate-modified epoxy resins; epoxy ester resins; aromatic epoxy resins; and mixtures thereof.

Where applicable, certain of these thermosetting resins may require a hardener or (reactive) curing agent in order to facilitate cure. The choice of hardener or curing agent is not particularly limited, except that it must comprise functional groups suitable for reacting with the functional groups on the thermosetting resins in order to affect cross-linking.

The epoxy resin may also be polymeric, suitable examples of which include linear polymers having terminal epoxy groups, for example a diglycidyl ether of a polyoxyalkylene glycol; polymer skeletal oxirane units, for example polybutadiene polyepoxide; and polymers having pendant epoxy groups, for example a glycidyl methacrylate polymer or copolymer.

In an embodiment, the binder resin of the composition comprises an epoxy resin selected from cycloaliphatic epoxy resins; cycloaliphatic epoxy resins modified with glycols; hydrogenated aromatic epoxy resins; epoxy phenolic novolac resins and cresol novolac type epoxy resins; bisphenol A-based epoxy resins; bisphenol F-based epoxy resins; and mixtures thereof.

Here, a cycloaliphatic epoxy resin is a hydrocarbon compound containing at least one non-aryl hydrocarbon ring structure and containing one, two or more epoxy groups. The cycloaliphatic epoxy compound may include an epoxy group fused to the ring structure and/or an epoxy group residing on an aliphatic substituent of the ring structure. It is preferred herein that the cycloaliphatic epoxy resin has at least one epoxy group residing on an aliphatic substituent of the ring. And suitable cycloaliphatic epoxy resins are described in U.S. Pat. Nos. 2,750,395; 2,890,194; 3,318,822; and 3,686,359, the disclosures of each of which hereby being incorporated herein in their entirety.

The binder resin of the composition may comprise a hydrogenated aromatic epoxy resin, a cycloaliphatic epoxy resin or a mixture thereof. In particular, the binder resin may comprise an epoxy resin selected from 1,2-cyclohexanedicarboxylic acid diglycidyl ester; bis(4-hydroxycylohexyl)methanediglycidyl ether; 4-methylhexahydrophthalic acid diglycidyl ester; 2,2-bis(4-hydroxycyclohexyl)propane diglycidyl ether; 3,4-epoxycyclohexylmethyl-3′,4′-epoxycylohexane carboxylate; bis(3,4-epoxycyclohexylmethyl)adipate; and mixtures thereof. Good results have, in particular, been obtained where the cycloaliphatic epoxy resins include: 1,2-cyclohexanedicarboxylic acid diglycidyl ester; 2,2-bis(4-hydroxycyclohexyl)propane diglycidyl ether; or mixtures thereof.

In an embodiment directed to a die attach paste, the binder resin comprises mixture of epoxy resin and flexible epoxy resin, the combination of which aids to decrease the stress after the cure, and therefore, to improve the reliability of the cured product.

An example of a flexible epoxy resin is illustrated by the formula (1) below.

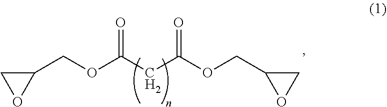

wherein n is greater than 20, preferably 26.

The isocyanate modified epoxy resins can have oxazolidine functionality if the isocyanate reacts directly with the epoxy, or ureido functionality if the isocyanate reacts with secondary hydroxyl groups present in the epoxy molecule. Commercially available examples of isocyanate- or urethane-modified epoxy resins useful herein include: EPU-17T-6, EPU-78-11, and EPU-1761, from Adeka Co.; DER 6508, from Dow Chemical Co.; and AER 4152, from Asahi Denka.

The thermosetting resin should be present in the binder resin in an amount of about 40 to about 60 percent by weight.

In addition to the thermosetting resin, also included in the binder resin are silane adhesion promoters and curing agents.

The silane adhesion promoter may be selected from gamma glycidoxypropyltrimethoxysilane, gamma-methacryloxypropyltrimethoxy silane, and (3,4-epoxycyclohexyl)ethyltrimethoxysilane.

The silane adhesion promoter should be present in the binder resin in an amount of about 1 to about 10 percent by weight, such as about 3 to about 5 percent by weight.

The curing agent may be selected from anhydrides, such as dodecenylsuccinic anhydride, methylhexahydrophthalic anhydride, methyltetrahydrophthalic anhydride, and nadic methyl anhydride.

The curing agent should be present in the binder resin in an amount of about 40 to about 60 percent by weight, such as about 45 to about 55 percent by weight.

The thermosetting resin and the curative should be present in about a 1:1 equivalent ratio.

The binder resin itself as noted should be present in an amount of about 2 to about 15 percent by weight, such as about 3 to about 12 percent by weight, desirably about 5 to about 10 percent by weight.

The silver particle component may be a single type of silver or one or more types of silver. For instance, the silver particle may be present in the range of about 65 percent by weight to about 93 percent by weight and be referred to as a silver powder. This silver powder can be a pure silver powder, a metal particle coated with silver on its surface, or a mixture thereof. The silver powder can be a commercially available product or may be prepared methods known in the art, such as mechanical milling, reduction, electrolysis and vapor phase processes.

Where a metal particle coated with silver on its surface is used as at least a portion of the silver powder, the core of the particle may be constituted by copper, iron, zinc, titanium, cobalt, chromium, tin, manganese or nickel or alloys of two or more of the metals, and the coating of silver should constitute at least 5 percent by weight, preferably at least 20 percent by weight and more preferably at least 40 percent by weight based on the weight of the particle. Such a silver coating may be formed by electroless Ag-plating, electroplating or vapor deposition, as is known in the art.

The silver powder present in the composition may be characterized by at least one of: i) a mass median diameter particle diameter (D50) of from 0.3 to 8 μm, preferably from 0.3 to 7.0 μm, more preferably from 0.3 to 6.0 μm, and even more preferably from 0.5 to 4.0 μm; ii) a specific surface area of less than 1.2 m²/g, preferably less than 1.0 m²/g; and iii) a tap density of from 3.5 to 8.0 g/cm³, preferably from 4 to 6.5 g/cm³.

The silver powder will generally have a maximum particle diameter (D100) of less than 75 μm, for example less than 60 μm, less than 50 μm, less than 30 μm, or of less than 25 μm. Alternatively, or additionally, the silver powder may have a D90 diameter of less than 20 μm, for example less than 15 μm, such as less than 10 μm.

The D50 (mass median diameter), D90 and D100 particle sizes may be obtained using conventional light scattering techniques and equipment, such as Hydro 2000 MU, available from: Malvern Instruments, Ltd., Worcestershire, United Kingdom; or Sympatec Helos, Clausthal-Zellerfeld, Germany.

The “tap density” of the particles recited herein is determined in accordance International Organization for Standardization (ISO) Standard ISO 3953. The principle of the method specified is tapping a specified amount of powder in a container—ordinarily a 25 cm³ graduated glass cylinder—by means of a tapping apparatus until no further decrease in the volume of the powder takes place. The mass of the powder divided by its volume after the test gives its tap density.

The “specific surface area” refers to the surface area per unit mass of the particles concerned. As is known in the art, the Brunauer, Emmett, and Teller (BET) method may be employed to measure the specific surface area of said particles, which method include the steps of flowing gas over a sample, cooling the sample, and subsequently measuring the volume of gas adsorbed onto the surface of the sample at specific pressures.

Commercially available silver powders suitable for use herein include FA-SAB-534, FA-SAB-573, FA-SAB-499, FA-SAB-195, FA-SAB-238, Ag-SAB-307, and Ag-SAB-136 available from Dowa; P554-19, P620-22, P698-1, P500-1, SA-31812, P883-3, SA0201, and GC73048 available from Metalor; SF134, SF120, and SF125 available from Ames-Goldsmith; TC756, TC505, TC407, TC466, and TC465 available from Tokuriki.

Optionally, the larger silver particle, or the silver powder, can be blended with second smaller silver particle to have a bimodal silver system. For example, use of a larger silver particle (having a tap density of about 5.7 g/cm³; a surface area of about 0.6 m²/g; a D50 of about 2.1 μm), and a smaller silver particle (having a tap density 4.2 g/cm³; a surface area of about 0.96 m²/g; a D50 of about 1.2 μm).

Where two silver particle types are used, the larger silver particle, the silver powder, should be present in an amount of about 10 to about 90 percent by weight, such as about 20 to about 80 percent by weight of total silver powder. The second silver particle type should have a particle size in the range of about 0.3 to about 2 μm. Where two silver particle types are used, the second (or smaller) silver particle is of a smaller size than the first (or larger) particle type.

The silver particle component should be present in the composition in an amount of about 65 to about 93 percent by weight, such as about 75 to about 93 percent by weight, desirably about 85 to about 93 percent by weight of the composition. Above about 93 percent by weight, the cured or sintered composition achieves a desirable thermal conductivity but becomes too brittle and causes too high stress for the semiconductor package with which it is used. Such high stress on the semiconductor package may lead to failure during temperature cycling, for instance.

Accordingly, maintaining or reducing the amount of silver to about 93 percent by weight or below and including a filler, such as described herein, achieves the desired thermal conductivity without compromising the strength of the cured or sintered composition.

The filler may be chosen from polymeric materials, inorganic materials and combinations thereof. The polymeric materials should not dissolve or swell in the liquid resin and solvent in the formulation. Nor should the polymeric materials melt during the cure process. The polymeric materials can be thermoset polymers or thermoplastic polymers, provided the polymeric materials have a melting point above the cure temperature of the thermosetting resin of the binder resin.

Examples of polymeric materials include divinylbenzene polymeric material, commercially available from Sekisui Chemical Co., having a particle size of about 3.0 μm; PTFE (commonly known as TEFLON), commercially available from Dupont, having an average particle size of about 3 μm and a specific area within the range of about 1.5 to about 3 m²/g.

Examples of inorganic materials include SE6050, commercially available from Admatechs, which describes the product as a silica particle, having a mean particle size of about 1.7 to about 2.3 μm, and a specific area of about 1.7 to about 2.9 m²/g.

The filler should have a particle size in a range of about 1 to about 20 μm, such as about 1 to about 10 μm, which may vary depending on the nature and identity of the filler chosen.

The filler should be used in an amount of about 1 to about 15 percent by weight, such as about 1 to about 10 percent by weight, desirably about 2 to about 7 percent by weight.

The electrically conductive composition may include a diluent in an amount of from 0 to about 10 percent by weight, for example from 0 or 0.1 to about 8 percent by weight, based on the total weight of the composition. Broadly, suitable diluents may be selected from alcohols including high boiling point alcohols; aromatic hydrocarbons; saturated hydrocarbons; chlorinated hydrocarbons; ethers including glycol ethers; polyols; esters including dibasic esters and acetates; kerosene; ketones; amides; heteroaromatic compounds; and mixtures thereof.

The diluent should have a high boiling point, such that it does not evaporate during the disposition of the composition. To that end, the diluent should have a boiling point of at least 115° C. at 1 atmosphere pressure. And the diluents should also have a melting point of less than 25° C. Examples of such diluents include dipropylene glycol, ethylene glycol, diethylene glycol, triethylene glycol, hexylene glycol, 1-methoxy-2-propanol, diacetone alcohol, 2-ethyl-1,3-hexanediol, tridecanol, 1,2-octanediol, butyldiglycol, alpha-terpineol or beta-terpineol, 2-(2-butoxyethoxy)ethyl acetate, 2,2,4-trimetyl-1,3-pentanediol diisobutyrate, 1,2-propylene carbonate, carbitol acetate, butyl carbitol acetate, butyl carbitol, ethyl carbitol acetate, 2-phenoxy ethanol, hexylene glycol, dibutylphthalate, dibasic ester (DBE), dibasic ester 9 (DBE-9), dibasic ester 7 (DBE-7), and mixtures thereof. Particularly desirable examples of such diluents include carbitol acetate; butyl carbitol acetate; dibasic ester (DBE); dibasic ester 9 (DBE-9); dibasic ester 7 (DBE-7); and mixtures thereof.

The electrically conductive composition may further include additives and modifiers. These additives and modifiers serve many functions. For instance, the additives and modifiers may be used to stabilize the composition to improve shelf life or service time and/or to control rheology, substrate adhesion and appearance. The additives and modifiers may also help to maintain the desired contact angle between the electrically conductive composition and the substrate. Suitable additives and modifiers include thickeners; viscosity modifiers; rheology modifiers; wetting agents; leveling agents; adhesion promoters; and de-foaming agents.

The additives and modifiers (such as rheology modifiers), when used, will ordinarily be included in an amount up to 10 percent by weight, for example from 0.01 to 5 percent by weight, such as about 0.01 to about 1 percent by weight, based on the total weight of the composition.

Suitable rheology modifiers include cellulosic materials, such as carboxymethylcelluose (CMC), hydroxyethylcellulose (HEC), methylcellulose (methocel, or MC), methyl hydroxyethyl cellulose (MHEC), and methyl hydroxypropyl cellulose (MHPC); colloidal silicas; metal organic gellants based, for example, on either aluminate, titanate, or zirconate; natural gums, such as alginate, carrageen, guar, and/ or xanthan gums; organo-clays, such as attapulgite, bentonite, hectorite, and montmorrillonite; organo-waxes, such as castor oil derivatives (HCO-Wax) and/or polyamide-based organowaxes; polysaccharide derivatives; and starch derivatives. A commercially available example of a suitable rheology modifier is Crayvallac® Super available from Arkema Inc.

In a particularly desirable embodiment, the binder resin comprises: i) a hydrogenated aromatic epoxy resin and/or a cycloaliphatic epoxy resin as described herein; and ii) a further epoxy resin selected from urethane-modified epoxy resins; isocyanate-modified epoxy resins; epoxy ester resins; aromatic epoxy resins; and mixtures thereof. For example, the binder may comprise: i) from 40 to 100 percent by weight, preferably from 50 to 90 percent by weight, based on the total weight of binder resin, of the cycloaliphatic resin and/or hydrogenated aromatic epoxy resin; and ii) from 0 to 60 percent by weight, preferably from 10 to 50 percent by weight of the further epoxy resin. A particular binder resin may, for example, have from 55 to 65 percent by weight of a cycloaliphatic resin and from 35 to 45 percent by weight of a modified urethane or isocyanate epoxy resin.

The electrically conductive composition is formed by combining the silver particles, the binder resin, any diluent or hardener required and any additives. The composition may be agitated during mixing of its components and/or subjected to a milling process after its formation in order to prevent or break up any particle aggregations. The selection of diluents and other liquid vehicles, and the particle loading should serve to provide a composition having a viscosity suitable for application by dispensing such as needle dispensing, jet dispensing, or by printing using, for instance, stencil printing, screen printing and the like. The skilled practitioner will be able to optimize the viscosity of the composition for specific printing methods.

Upon completion of sintering and curing, the sintered product may be cooled either in the same atmosphere used for sintering or in some other atmosphere as might be required to maintain the resin matrix. The sintering and cooling atmospheres should have no significant deleterious effect on the cured composite.

The electrically conductive composition may be used as a die-attach paste, especially in high power die attach applications where high thermal conductivity—or low thermal resistivity—and thus good heat distribution is required. The paste serves to attach the semiconductor die to an appropriate substrate but, upon sintering of the constituent silver particles, also forms a metallurgical bond between electrical terminals on the die and corresponding electrical terminals on the substrate. These sinterable die-attach pastes are stable in that they do not change or re-melt during subsequent thermal processing, such as the attachment of the element to a circuit board. Moreover, the composition can also be applied at the wafer level prior to the singulation of the individual die.

Typically, a drop of the electrically conductive composition is dispensed on the substrate and the die placed on top of it so that the composition is sandwiched between the substrate and the die, thereby forming a die/substrate package. The die is contacted to the composition with a sufficient degree of pressure and/or heat so that the composition spreads and completely covers the substrate under the die. It is desirable that the composition further forms a fillet, that is, a raised rim or ridge, at the periphery of the die. A skilled practitioner can determine the appropriate amount of electrically conductive composition, heat and pressure to apply so that the resultant die-attach fillet is of an appropriate size.

When so disposed between the substrate and the die, the electrically conductive composition needs to be heated for a sufficient time to both sinter the silver powder contained in said composition and to fully cure the composition. Typically, the die/substrate package is placed in a furnace: the package may pass through a plurality of different temperature zones of incrementally increasing temperature up until a final zone having a temperature of, ideally, from 100° to 250° C. The ramp rate—the rate at which the temperature of the package is elevated—is selected to control both the evaporation of any volatiles in the electrically conductive composition and the commencement of sintering prior to the complete curing of the binder resin therein. Further, it is important that the evaporation of volatiles and rate of curing of the binder resin does not lead to the formation of any voids in the final adhesive layer. A ramp rate of from 30° to 60° C./minute may be suitable. Independently, a 15 to 90 minute residence time of the package in the final zone of the furnace may be appropriate.

The viscosity of the electrically conductive composition should be measured at 25° C., unless otherwise stated, employing a TA Instruments Rheometer using either: i) 2 cm plate, 500 micron gap and shear rates of 1.5 s⁻¹ and 15 s⁻¹; or ii) 2 cm plate, 200 micron gap and shear rates as indicated below (10 s⁻¹ and 100 s⁻¹).

Where the Volume Resistivity (VR) of the cured electrically conductive composition is given herein, this parameter may be determined in accordance with the following protocol: i) samples of the composition were prepared for the compositions on glass plates at a wet thickness of approximately 40 μm and a sample length of more than 5.4 cm; ii) the samples were cured according to the requirement for the binder resin used; iii) the glass plates were cooled to room temperature before measurement of sample thickness using a Mutitoyo Gauge and sample width using a back-light microscope; iv) Resistance (R) was measured by using Keithley 4 point probes over a 5.4 cm sample length; and v) Volume Resistivity was calculated from the equation VR=(width of the sample (cm)×thickness of the sample (cm)×Resistance (Ohm))/length of the sample (cm). In the Examples below, Volume Resistivity (VR) is an average of three duplicate measurements each made in accordance with this protocol.

A “die” is a singular, semi-conductive element disposed on a semiconductor wafer and generally separated from its neighboring die(s) by scribe lines. After semiconductor wafer fabrication steps are completed, the die are generally separated into elements or units by a die singulation process, such as sawing.

### EXAMPLES

### Examples 1-4

To form the electrically conductive compositions described in Table 1 herein below, the binder resin, the silver components, the fillers and the diluent were mixed together under appropriate conditions and for a time sufficient to ensure proper mixing with little to no observable silver and/or filler aggregation. The compositional values given in Table 1 are percent by weight, based on the total weight of the composition. The compositions were then evaluated as noted below.

TABLE 1

| | | | Sample Nos./Amt (wt %) | | | |
|---|---|---|---|---|---|---|
| Constituents | | | 1 | 2 | 3 | 4 |
| Resin binder | DDSA | curing agent | 7.9 | 7.7 | 5.8 | 5.8 |
| | (Dodecenylsuccinic anhydride) | | | | | |
| | EPALLOY 5200 | epoxy resin | | | | |
| | Epoxy formula (1) | | | | | |
| | Glycidoxypropyl | silane adhesion | | | | |
| | trimethoxysilane 6040 | promoter | | | | |
| | SILQUEST A174 NT | | | | | |
| Silver | Silver 1 | Ag flake, tap density 5.7 | 91.0 | 87.5 | 86.3 | 86.3 |
| | | g/cm3, SA 0.6 M2/g, | | | | |
| | | D50 = 2.1 μm | | | | |
| Fillers | Divinylbenzene polymer particle | size 3.0 μm | — | 3.0 | — | — |
| | PTFE | size 3 μm, specific area | — | — | 5.0 | — |
| | | 1.5-3 m2/g | | | | |
| | SE6050 | silica particle, mean size | — | — | — | 5.0 |
| | | 1.7~2.3 μm, specific | | | | |
| | | area 1.7~2.9 m2/g | | | | |
| Diluent | 2-(2-Butoxyethoxy)ethyl Acetate | | 1.1 | 1.8 | 3.0 | 3.0 |
| | Total | | 100 | 100 | 100 | 100 |

Once cured, the total silver in a percent by weight basis for Sample Nos. 1-4 is 92, 89, 89 and 89, as once cured the diluent is no longer present.

TABLE 2

| | Sample Nos. | | | |
|---|---|---|---|---|
| Physical Properties | 1 | 2 | 3 | 4 |
| 260° C. DSS on PPF | 21.0 | 23.0 | 19.7 | 19.3 |
| (kg/5 × 5 mm die) | | | | |
| 260° C. DSS on PPF | 34.3 | 40.8 | 32.2 | 49.6 |
| (kg/7 × 7 mm die) | | | | |
| Volume resistivity | 3.5E−06 | 7.2E−06 | 1.4E−05 | 1.0E−05 |
| (ohm · cm) | | | | |
| Thermal conductivity, W/m · K | 83.5 | 80.6 | 81.3 | 88.8 |
| Modulus @ 25° C. (GPa) | 20.4 | 11.8 | 13.2 | 17.3 |
| Modulus @ 250° C. (GPa) | 10.4 | 5.7 | 6.6 | 7 |

With reference to Tables 1 and 2, compared to higher silver loading of Sample No. 1 (i.e., 92 wt %), each of Sample Nos. 2-4 have lower silver loading, yet demonstrate similar or even stronger die shear strength at a temperature of 260° C. for large die (i.e., 5×5 mm and 7×7 mm) and lower modulus at a temperature of 25° C. and 250° C. This demonstrates the effect of filler particles to improving sintering paste adhesion strength at lower silver loadings and lower modulus observations.

Die Shear Strength (DSS): Samples of each composition were disposed to a thickness of 50 microns between each of a 5×5 mm and a 7×7 mm silver die and a PPF (nickel-palladium-gold) lead frame. The temperature of each die substrate package was then raised from 25° C. to 200° C. over a period of approximately 2 hours before being held at 200° C. for a 60 minute period to cure the composition. Each sample was cooled to room temperature and was then tested for die shear strength; each test was conducted at least twice per sample. The results were collated and averaged, and the die shear strength reported in Table 2.

Thermal Conductivity: Samples of each composition were disposed in a Teflon mold having a width of 25 mm and depth (thickness) of 0.7 mm. The temperature of the composition was then raised from 25° C. to 200° C. over a period of approximately 2 hours before being held at 200° C. for a 60 minute period to cure the composition and thereby form thermal diffusivity pellets. The thermal conductivity of the pellets was then determined via laser flash in accordance with the test method specified in ASTM E 1461.

### Examples 5-11

To form the electrically conductive compositions described in Table 3 herein below, the binder resin, the silver particle component, the filler and the diluent were mixed together under appropriate conditions and for a time sufficient to ensure proper mixing with little to no observable silver and/or filler aggregation. The compositional values given in Table 3 are percent by weight, based on the total weight of the composition. The compositions were then evaluated as noted below.

TABLE 3

| | | | Sample Nos./Amt (wt %) | | | | | | |
|---|---|---|---|---|---|---|---|---|---|
| Constituents | | | 5 | 6 | 7 | 8 | 9 | 10 | 11 |
| Resin | DDSA | curing agent | 7.9 | 8.9 | 10.9 | 11.9 | 7.7 | 7.5 | 7.5 |
| binder | (Dodecenylsuccinic anhydride) | | | | | | | | |
| | EPALLOY 5200 Epoxy formula (1) | epoxy resin | | | | | | | |
| | Glycidoxypropyl trimethoxysilane | silane | | | | | | | |
| | 6040 | adhesion | | | | | | | |
| | SILQUEST A174 NT | promoter | | | | | | | |
| Silver | Silver 1 | Ag flake, tap | 63.3 | 62.9 | 62.0 | 61.6 | 60.8 | 59.5 | 59.5 |
| | | density 5.7 | | | | | | | |
| | | g/cm3, SA 0.6 | | | | | | | |
| | | m2/g, D50 = | | | | | | | |
| | | 2.1 μm | | | | | | | |
| | Silver 2 | Ag powder, | 27.1 | 27.0 | 26.6 | 26.4 | 26.1 | 25.5 | 25.5 |
| | | tap density 4.2 | | | | | | | |
| | | g/cm3, SA 0.96 | | | | | | | |
| | | m2/g, D50 = | | | | | | | |
| | | 1.2 μm | | | | | | | |
| Fillers | Divinylbenzene | size 3.0 μm | — | — | — | — | 3.0 | — | — |
| | polymer | | | | | | | | |
| | PTFE | size 3 μm, | — | — | — | — | — | 5.0 | — |
| | | specific area | | | | | | | |
| | | 1.5-3 m2/g | | | | | | | |
| | SE6050 | silica particle, | — | — | — | — | — | — | 5.0 |
| | | mean size | | | | | | | |
| | | 1.7~2.3 μm, | | | | | | | |
| | | specific area | | | | | | | |
| | | 1.7~2.9 m2/g | | | | | | | |
| Diluent | 2-(2-Bμmtoxyethoxy)ethyl Acetate | | 1.8 | 1.3 | 0.6 | 0.0 | 2.5 | 2.4 | 2.4 |
| | Total | | 100 | 100 | 100 | 100 | 100 | 100 | 100 |

Once the diluent has evaporated and the binder resin cured, the silver loading in percent by weight in Sample Nos. 5-11 was 92, 91, 89, 88, 89, 87 and 87, respectively.

The performance of Sample Nos. 5-11 is captured and shown below in Table 4.

TABLE 4

| | Sample Nos. | | | | | | |
|---|---|---|---|---|---|---|---|
| Physical Properties | 5 | 6 | 7 | 8 | 9 | 10 | 11 |
| 260° C. DSS on PPF | 23 | 24 | 5.7 | 6 | 26.2 | 22.4 | 25.2 |
| (kg/5 × 5 mm die) | | | | | | | |
| 260° C. DSS on PPF | 40.1 | 28.3 | 9.1 | 7.9 | 44 | 27.9 | 26.1 |
| (kg/7 × 7 mm die) | | | | | | | |
| Volume resistivity (ohm · cm) | 4.8E−06 | 5.5E−06 | 5.4E−06 | 5.9E−06 | 7.8E−06 | 7.0E−06 | 7.3E−06 |
| Thermal conductivity, W/m · K | 56 | 28.1 | 6.7 | 3.8 | 70 | 83.9 | 81.1 |
| Modulus @ 25° C. (GPa) | 19.1 | 18.4 | 14.8 | 12.9 | 14.6 | 12.5 | 18.6 |
| Modulus @ 250° C. (GPa) | 7.7 | 6.9 | 3.1 | 3.1 | 6.3 | 6.1 | 6.2 |

With reference to Tables 3 and 4, bimodal silver filled compositions are set forth as Sample Nos. 5-8 and bimodal silver filled compositions with filler particles are set forth as Sample Nos. 9-11.

Each of Sample Nos. 9-11 have lower silver loading than Sample Nos. 5-8, yet demonstrate similar or even stronger die shear strength at a temperature of 260° C. for large die (i.e., 5×5 mm and 7×7 mm) and lower modulus at temperatures of 25° C. and 250° C. Interestingly, Sample Nos. 9-11 also demonstrate significantly higher thermal conductivity. This demonstrates the effect of filler particles to improving sintering paste adhesion strength at lower silver loadings, lower modulus and increased thermal conductivity observations.

Ordinarily, at lower silver loading (e.g., less than about 90 percent by weight), sintering may not happen at all or if it does may be very poor. However, at such lower silver loading with the addition of filler particles improved sintering paste adhesion strength at lower silver loadings, lower modulus and increased thermal conductivity may be observed.

What is claimed is:

1. A curable or sinterable composition, comprising:
in an amount of about 2 to about 15 percent by weight, a binder resin comprising a thermosetting resin; a silane adhesion promoter; and a curing agent;
in an amount of about 65 to about 93 percent by weight, a silver particle component;
in an amount of about 1 to about 10 percent by weight, one or more fillers having a particle size in a range of about 1 μm to about 20 μm, and selected from the group consisting of polymeric materials, inorganic materials and combinations thereof; and
optionally an organic diluent,
wherein
the composition, when cured or sintered, has a shear strength on 7×7 mm die of at least 25 kg/mm 2 at 260° C.; and
the composition demonstrates a thermal conductivity of 70 W/m·K.

2. The electrically conductive composition according to claim 1, wherein the silver particle component comprises silver particles having two different particle size ranges.

3. The electrically conductive composition according to claim 1, wherein the silver particle component comprises silver powder having a tap density of between 1 to about 7 g/cm³ and silver flake having a tap density of between 1 to about 7 g/cm³.

4. The electrically conductive composition according to claim 1, wherein the silver particle component has a mass median diameter (D50) of from 0.3 to 6.0 um.

5. The electrically conductive composition according to claim 1, wherein the specific surface area of the silver particle component is less than 1.5 m²/g.

6. The electrically conductive composition according to claim 1, wherein the binder resin comprises a hydrogenated aromatic epoxy resin, a cycloaliphatic epoxy resin or a mixture thereof.

7. The electrically conductive composition according to claim 1, wherein the binder resin comprises an epoxy resin selected from the group consisting of 1,2-cyclohexanedicarboxylic acid diglycidyl ester; bis(4-hydroxycylohexyl)methanediglycidyl ether; 4-methylhexahydrophthalic acid diglycidyl ester; 2,2-bis(4-hydroxycyclohexyl)propane diglycidyl ether; 3,4-epoxycyclohexylmethyl-3′,4′-epoxycylohexane carboxylate; bis(3,4-epoxycyclohexylmethyl)adipate and mixtures thereof.

8. The electrically conductive composition according to claim 1, wherein the binder resin further comprises an epoxy resin selected from the group consisting of urethane-modified epoxy resins; isocyanate-modified epoxy resins; epoxy ester resins; aromatic epoxy resins; and mixtures thereof.
